(19) United States
(12) Patent Application Publication
(10) Pub. No.: US 2025/0299121 A1
(43) Pub. Date: Sep. 25, 2025

(54) SYSTEMS AND METHODS FOR ARTIFICIAL INTELLIGENCE-DRIVEN CANDIDATE SELECTION

(71) Applicant: Optum Services (Ireland) Limited, Dublin (IE)

(72) Inventors: Conor John WALDRON, Dublin (IE); Breanndan O'CONCHUIR, Warrington (GB); Daniel KELLY, Dublin (IE); Lisa E. WALSH, Dublin (IE)

(21) Appl. No.: 18/610,822

(22) Filed: Mar. 20, 2024

(51) Int. Cl. G06Q 10/0631; G06N 5/022

(52) U.S. Cl. CPC G06Q 10/063112; G06N 5/022

(57) ABSTRACT

Systems and methods are disclosed for enhancing data. One or more processors may receive a data object associated with a user that includes a first parameter initially set to a first value. One or more processors may determine, based on a comparison of parameters of the data object with corresponding parameters of data objects associated with other users, that one or more of (1) a second value should override the first value or (2) a second parameter should be added into the data object. One or more processors may generate an augmented data object by modifying the data object to include the second value or the second parameter based on the determining. One or more processors may store or delete information about the user in memory based on the augmented data object.

### TECHNICAL FIELD

The present disclosure relates generally to data-driven project management. More particularly, the present disclosure relates to adaptation of machine learning and/or rules-based techniques for prescreening and retention of program entities.

### BACKGROUND

In the context of data-driven project management, the selection and retention of data set entries are tasks that generally require attention for maintaining the integrity and effectiveness of the project. Conventional techniques in data set management often depend on preliminary assessments based on reported entry attributes and responses, which might not accurately represent the actual characteristics or reliability of these entries. This misalignment can lead to computational and/or logistical inefficiencies in data set management, impacting the project's integrity and efficiency.

Existing methodologies for managing extensive data sets face challenges in predicting and maintaining the quality and completeness of the data sets. These methods predominantly react to historical trends and subjective evaluations of entry suitability and consistency. As a result, these approaches may not effectively identify and mitigate factors contributing to entry inaccuracy or dropout, such as unreported attributes or changes in entry status, again leading to computational and/or logistical inefficiencies in managing data sets.

This disclosure is directed to addressing the above-mentioned challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The present disclosure addresses the technical problem(s) described above or elsewhere in the present disclosure and improves the state of data incident response techniques.

In some aspects, the techniques described herein relate to a computer-implemented method including: receiving, by one or more processors, a data object associated with a user that includes a first parameter initially set to a first value; determining, by the one or more processors and based on a comparison of parameters of the data object with corresponding parameters of data objects associated with other users, that one or more of (1) a second value should override the first value or (2) a second parameter should be added into the data object; generating, by the one or more processors, an augmented data object by modifying the data object to include the one or more of the second value or the second parameter based on the determining; and storing or deleting, by the one or more processors, information about the user in memory based on the augmented data object.

In some aspects, the techniques described herein relate to a system including memory and one or more processors communicatively coupled to the memory, the one or more processors configured to: receive a data object associated with a user that includes a first parameter initially set to a first value; determine, based on a comparison of parameters of the data object with corresponding parameters of data objects associated with other users, that one or more of (1) a second value should override the first value or (2) a second parameter should be added into the data object; generate, by the one or more processors, an augmented data object by modifying the data object to include the one or more of second value or the second parameter based on the determining; and store or delete, by the one or more processors, information about the user in memory based on the augmented data object.

In some aspects, the techniques described herein relate to one or more non-transitory computer-readable storage media including instructions that, when executed by one or more processors, cause the one or more processors to: receive a data object associated with a user that includes a first parameter initially set to a first value; determine, based on a comparison of parameters of the data object with corresponding parameters of data objects associated with other users, that one or more of (1) a second value should override the first value or (2) a second parameter should be added into the data object; generate, by the one or more processors, an augmented data object by modifying the data object to include the one or more of second value or the second parameter based on the determining; and store or delete, by the one or more processors, information about the user in memory based on the augmented data object.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1A is a diagram showing an example of a system environment, according to some embodiments of the disclosure.

FIG. 1B is a diagram of example components of a data management platform, according to some embodiments of the disclosure.

FIG. 1C is a diagram of example components of a data enhancement module, according to some embodiments of the disclosure.

FIG. 2 is a flowchart showing a method for data enhancement, according to some embodiments of the disclosure.

FIG. 3 shows an example machine-learning training flow chart, according to some embodiments of the disclosure.

FIG. 4 illustrates an implementation of a computer system that executes techniques presented herein, according to some embodiments of the disclosure.

### DETAILED DESCRIPTION

The present disclosure pertains to the realm of clinical study management, e.g., with regard to data analytics and artificial intelligence. This disclosure encompasses techniques for enhancing participant selection and retention in clinical studies. Specifically, techniques are disclosed that introduce systems and methods designed to improve and/or optimize the prescreening process and improve participant retention by leveraging machine learning and rules-based approaches.

Traditional approaches in clinical study or trial management often struggle with accurately identifying and retaining suitable participants, or members. These conventional methods typically rely on preliminary assessments based on member data sourced from member medical histories and diagnoses, which may not fully capture the real conditions of the member or the likelihood of their continued participation in the study. Further, conventional methodologies fall short in identifying a risk of attrition associated with each member, thereby leaving gaps in member data related to the consistency and reliability of the potential participant pool. Additionally, these approaches lack the capability to identify member-specific factors that are instrumental in driving tailored interventions during the trial, which impacts the likelihood of retaining members throughout the study duration. Such limitations can lead to inefficiencies and reduced effectiveness in managing and retaining study participants.

To address these concerns, the present disclosure provides systems and methods to refine and enhance the selection process for clinical trial members. The techniques provided in the present disclosure leverage machine-learning and/or a rules-based approach to identify underlying conditions in potential members, e.g., even in cases where these conditions have not been clinically diagnosed. By employing machine learning models and/or a plurality of rules-based engines, the system analyzes member data to uncover indicators of relevant health conditions, which are then added to the member data set. The disclosed technique results in a number of technical advantages in at least several technical fields, including but not limited to data analytics, predictive analytics, artificial intelligence, business intelligence, and data visualization. For example, the system implementing the disclosed technique leads to an augmented member data set and a more accurately defined pool of candidates, which may improve accuracy of the identification of eligible individuals for the trial. Furthermore, the system more accurately predicts member dropout and/or retention rates, by leveraging predictive analytics to assess the likelihood of continued participation based on the enriched member data. This capability enables more precise targeting and selection of candidates who are not only eligible but also more likely to remain engaged throughout the duration of the trial. In addition to optimizing member selection, the system advantageously identifies key retention factors for each member. These factors inform targeted interventions, tailored to individual member needs, to support and enhance their retention during the trial. By addressing potential challenges proactively, the system plays a pivotal role in maintaining member engagement and ensuring the overall success and integrity of the clinical trial.

The technical improvements and advantages discussed above are not the sole improvements and advantages, and additional technical improvements and advantages will be discussed in the following sections. Further, based on the present disclosure, other technical improvements and advantages will be apparent to one of ordinary skill in the art.

By way of example, in a practical application of the system, consider a scenario where a member does not have a formal diagnosis for a specific target condition required for a clinical trial. However, the machine learning models and rules-based analysis employed by the system detect indicators in the member's health data that suggest the presence of this condition. Consequently, the system modifies the member's data to reflect this newfound eligibility, thus including them in the pool of potential participants for the trial.

Continuing the example, the member's profile undergoes further assessment to evaluate their retention risk. The system's predictive analytics classify the member as having a medium retention risk, indicating a moderate likelihood of them completing the trial. The retention assessment also identifies multiple retention factors specific to the member. In this example, a significant factor is the distance from the member's residence to the trial center, which is negatively correlated with their likelihood of trial completion.

Continuing the example, in response to the identification of this risk factor, the system suggests a tailored intervention to address this retention factor. For this member, it recommends providing transportation support for visits to the trial center. This intervention is likely to increase the member's engagement and adherence to the trial, thereby enhancing their chances of successfully completing it. This example demonstrates how the system's detailed analysis and personalized intervention strategies effectively improve participant retention and overall trial success.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the disclosure is not to be considered as limited by the foregoing description.

Various non-limiting embodiments of the present disclosure will now be described to provide an overall understanding of the principles of the structure, function, and use of systems and methods disclosed herein for resource allocation.

Reference to any particular activity is provided in this disclosure only for convenience and not intended to limit the disclosure. A person of ordinary skill in the art would recognize that the concepts underlying the disclosed devices and methods may be utilized in any suitable activity. For example, while the present disclosure is in the context of data enhancement, one of ordinary skill would understand the applicability of the described systems and methods to similar tasks in a variety of contexts or environments. Additionally, while examples above pertain to clinical trials, and moreover to selection of persons for inclusion in such a trial, techniques set forth in this disclosure may be applied or adapted to any suitable data-driven project involving selection and retention of entities (persons or otherwise). Non-limiting examples include testing of biological samples (e.g., in an in vitro trial), A-B testing (e.g., for software evaluation, product testing, or the like), market analysis, etc.

The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

Training the machine-learning model may include one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-Prototypes or K-Means may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc. After training the machine-learning mode, the machine-learning model may be deployed in a computer application for use on new input data that it has not been trained on previously.

As used herein, a “data object” encompasses, in any ordered combination, a comprehensive array of information as discussed herein, further incorporating metrics generated by the system, including in some embodiments outputs from one or more machine learning models. As pertains to a clinical trial, such data objects are structured to include member-specific information, which may comprise age, ethnicity, education level, employment status, medical insurance coverage, the distance from the member's address to the trial center, and the like. Additionally, the data object may contain Social Determinants of Health (SDOH), including, but not limited to, the poverty index associated with the member's home address categorized as high, medium, or low. In some embodiments, insurance claims and labs data, encompassing the number of primary care physician visits per year, the number of medications taken per year, and indicators of high blood sugar, along with features tailored for the disease of interest, and the like, are also integrated into the data object. One or more of the information entries into the data object may include weights or importance assigned to the entry, and the data object may be an input to a machine-learning model, an output of a machine learning model, and/or may be utilized as training data for a machine-learning model. Further, qualitative labels may be incorporated into the data object, such as a flag indicating an aspect of the user data, such as a member completing a prior trial. Further, data may be temporally oriented and/or arranged within the data object, such that data indicates temporally associated flags and information related to one or more member.

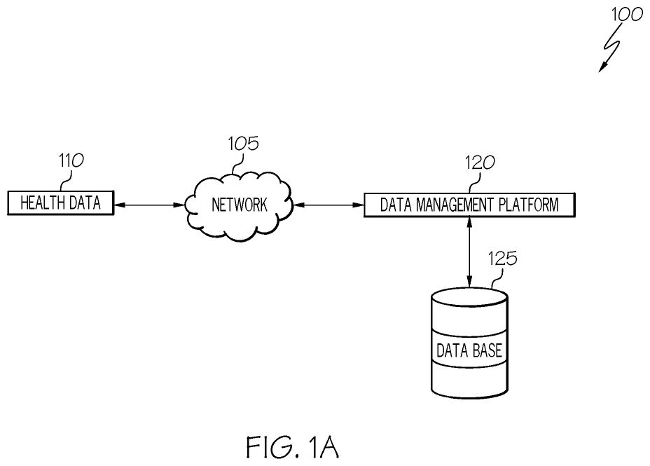

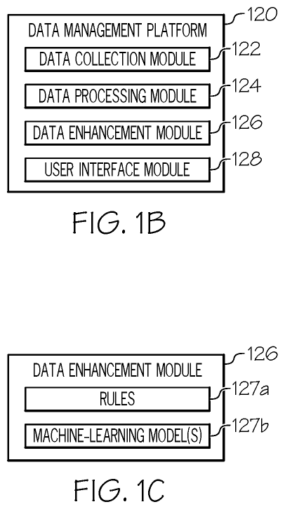

FIG. 1A is a diagram showing an example of a system environment, according to some embodiments of the disclosure. The depicted environment, labeled as environment 100, is presented in line with a particular embodiment of this disclosure. Environment 100 includes a communication infrastructure known as network 105, which is connected to health data 110, and further integrates with a data management platform 120 that incorporates a database 125.

In one embodiment, various components within environment 100 interact via network 105. Network 105 enables communication between data management platform 120 and other systems and/or data within the environment 100, such as health data 110. Health data 110 may contain data, data entries, and/or data objects relevant to individual patient records, clinical trial data, biometric information, or the like associated with the environment 100. Network 105 can comprise various types of networks, including but not limited to data networks, wireless networks, telephony networks, or any combination thereof, facilitating robust and secure data flow across environment 100. Within environment 100, any of these components, including health data 110 and data management platform 120, may communicate with one another based on established access permissions.

Any of the health data 110 associated with the data management platform 120 may contain a diverse collection of structured and unstructured data pertinent to clinical trial management and participant monitoring within the clinical trial environment. In some embodiments, this data, organized into one or more data objects, spans a variety of dimensions including participant demographics, health assessments, eligibility criteria, and other relevant medical and administrative data. This extensive repository, which includes health records, eligibility determinations, intervention records, and monitoring outcomes, is housed in storage solutions that may range from local to cloud-based data storage systems, ensuring secure storage and accessibility for ongoing processing, enhancement, and analytical evaluation.

The database 125 may support the storage and retrieval of various types of data related to one or more data sets and/or data objects, such as participant demographics, health assessments, eligibility criteria, and other relevant medical and administrative data for clinical trials. This database 125 stores metadata and operational data about one or more entities represented in these data sets, as well as any information received from the data management platform 120. The database 125, in some embodiments, includes one or more systems, including but not limited to a relational database management system (RDBMS), a NoSQL database, or a graph database, tailored to meet the specific needs and use cases within the clinical trial management environment.

In various embodiments, database 125 is any suitable type of database system, such as relational, hierarchical, object-oriented, etc., where data is systematically organized in tables, lookup tables, or other appropriate structures. Database 125 is configured to store and facilitate access to data utilized by data management platform 120, encompassing information related to trial participant tracking, operational logs, and outputs generated by the platform. Database 125 is further configured to store a wide variety of information to assist in the management, security, and operation of the clinical trial environment.

In one embodiment, database 125 includes a machine learning-based training database that delineates relationships, associations, and connections between input parameters from trial participant data and output parameters representing various metrics for trial efficiency, participant retention, and intervention effectiveness. For instance, the training database might incorporate machine learning algorithms designed to learn mappings between data inputs and outputs such as retention risk scores, efficacy indicators, side effect profiles, and the like. This training database is periodically updated to reflect additional insights gained through ongoing machine learning processes, thereby enhancing the accuracy and effectiveness of predictive models in identifying high-retention participants and optimizing clinical trial outcomes.

Data management platform 120 communicates with other components within network 105 using any suitable protocol. These protocols facilitate interactions between various system elements and define the conventions for creating, sending, and interpreting data exchanged across communication links. They function across different layers, ranging from the generation of physical signals to the recognition of specific software applications engaged in data analysis, enhancement, and clinical trial management decisions. This multilayered communication approach ensures seamless integration and coordination between the data management platform, data collection and processing modules, and machine learning algorithms, thereby enabling efficient and targeted management of clinical trial data.

Communications between the various components of the network are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers.

In operation, environment 100 serves as a platform for processing and analyzing trial participant data within the clinical trial management industry, utilizing techniques such as data analytics, artificial intelligence, and database management. For instance, environment 100 facilitates the generation of insights, metrics, and data objects from various datasets, including participant eligibility data and health assessments, according to predefined criteria or multiple parameters.

To execute these functions, the data management platform 120 employs methods such as one or more machine-learning models, such as an eligibility model and/or retention model, which interpret trial data to identify patterns, trends, and opportunities for optimizing clinical trial outcomes. Additionally, the data management platform 120 leverages the data collection module 122 and the data processing module 124 to aggregate and refine trial data for further enhancement and analysis.

For efficient data storage and access, the database 125 archives metadata associated with the trial data, including information about data origins, types, and structures. This database also retains details on the insights generated by the data management platform 120, such as participant retention scores, intervention effectiveness indicators, and statistical data.

Beyond trial data analysis, environment 100 supports a range of applications, including data visualization, search functionalities, and predictive modeling. For example, it enables users on one or more user devices to query trial data for specific metrics that meet certain criteria or to visualize trial statistics through dynamic graphs and charts.

FIG. 1B is a diagram of example components of a data management platform, according to some embodiments of the disclosure. This figure shows that the data management platform 120, as part of environment 100, has the functionality to analyze various datasets, such as trial participant and clinical data, and generate data objects, including insights and metrics relevant to clinical trial management. The terms “component” or “module” within this context refer to both hardware and software implemented by a processor or similar technology. Specifically, the data management platform 120 is equipped with modules for collecting, processing, enhancing trial data, and generating data objects. These include the data collection module 122, the data processing module 124, the data enhancement module 126, and the user interface module 128. The design allows for flexibility in how these modules are organized, with the possibility of integrating their functions into fewer modules or distributing them across different modules with similar capabilities.

In certain embodiments, the data collection module 122 of the data management platform 120 is configured to gather data from various sources and formats during the operation of environment 100. This module is configured to handle a wide range of data types, including, but not limited to, electronic health records, treatment outcomes, participant demographics, eligibility information, and trial performance data. Additionally, the data collection module processes proprietary or generated data like participant retention models, trial efficiency scores, and outcome analysis outputs.

The data is ingested into the data enrichment platform 120 via one or more pathways, thereby providing flexibility in the collection mechanism. Specifically, one pathway includes an Application Programming Interface (API) that establishes a secure communication channel for automated data transfer between the data collection module 122 and external trial data sources, thus facilitating real-time or batch-based data acquisition. Another pathway allows for manual input by authorized users via a dedicated user interface, where such input can be executed through file uploads or direct data entry into predefined fields. Additionally, data intake can be accomplished through third-party integrations, middleware, or direct database queries that serve to populate the database 125. The data collection module 122 further incorporates data validation and integrity checks to ensure the consistency and reliability of the ingested data. By offering a plurality of data intake methodologies, the data collection module 122 ensures robust and comprehensive data assimilation for downstream processing.

In some embodiments, the data processing module 124 of the data management platform 120 is involved in processing and preparing trial participant(s) and clinical data for further augmentation by the data enhancement module 126. The data processing module 124 undertakes the cleaning of data, elimination of irrelevant or redundant information, and conversion of the data into a format suitable for enhancement by the data enhancement module 126. The data processing module 124 is designed to augment the initial data collection by transforming the raw, diverse trial and clinical data into a unified, standardized format for accurate and efficient enhancement downstream. Specifically, the data processing module 124 employs a series of algorithms for data normalization, addressing inconsistencies in data formats, units, or terminologies from various trial data sources.

The data processing module 124 further integrates error-handling mechanisms to detect and correct possible data inaccuracies or anomalies within the trial data. These mechanisms can include rule-based checks, probabilistic data matching, or data imputation techniques, all aimed at maintaining data quality and integrity for clinical trial analytics. Additionally, the data processing module 124 may feature parallel processing capabilities to manage multiple trial data streams simultaneously, enhancing the timeliness and efficiency of data throughput. This attribute is especially beneficial for handling large datasets or facilitating real-time analytics, where rapid processing of trial participant and clinical data is critical.

Upon receiving the processed data from the data processing module 124, the data enhancement module 126 applies algorithms and models to generate one or more data objects, including insights and metrics relevant to clinical trial management and participant engagement strategies. The data enhancement module 126 utilizes a variety of algorithms and machine-learning models to achieve this, engaging in the computational analysis of the ingested trial and clinical data. Utilizing the machine-learning models such as rules 127a and machine-learning model(s) 127b as part of its analytical framework, the data enhancement module 126 employs a mix of algorithmic and machine-learning methodologies to produce metrics and data objects based on the input data. These metrics and data objects provide quantifiable insights into participant retention trends, eligibility criteria efficiency, and intervention effectiveness within the context of clinical trials.

After generating the data objects, including insights and metrics, a user interface presented on a user device through the user interface module 128 displays the results to the user in a timely manner. This interface offers an interactive and intuitive platform for users to view, analyze, or act upon the generated insights. It also allows users to provide feedback or input additional parameters to refine the analysis or adjust the models within the data management platform 120 accordingly. The user interface module 128 is configured to facilitate user interaction, enabling the input of parameters through an interactive interface, thereby enhancing the decision-making process for clinical trial management and participant engagement strategies.

FIG. 1C is a diagram of example components of a data enhancement module, according to some embodiments of the disclosure. FIG. 1C provides a more detailed view of the data enhancement module and its relationship with the rules 127a and machine-learning model(s) 127b within the data management platform 120. The data enhancement module 126 is designed to harness advanced analytical capabilities to process, analyze, and generate predictions from vast datasets related to trial participant behaviors, health trends, and other relevant clinical trial data. This module acts as the core analytical engine of the data management platform, integrating various predictive models and rules to support comprehensive clinical trial management strategies.

The data enhancement module 126 is equipped with algorithms that enable the data enhancement module 126 to perform a wide range of functions, from data preprocessing and feature extraction to the application of complex predictive models. The data enhancement module 126 is structured to facilitate the seamless integration and operation of specific models and rules tailored to address distinct aspects of clinical trial management. These predictive tools include one or more machine-learning models 127b, which are configured to enhancing trial data and identifying patterns and predictions related to trial participant behavior, such as retention risk or response to interventions. Additionally, rules 127a are implemented to apply predefined criteria for enhancing data integrity and relevance. Together, these components facilitate a comprehensive analytical framework to support decision-making and strategy formulation in the optimization of clinical trial outcomes.

In some embodiments, the data enhancement module 126 incorporates one or more rules 127a. Rules 127a framework enables the data enhancement module 126 to systematically apply a plurality of potential conditions to a trial participant's profile, contingent upon one or more states or flags discerned from the participant's data entries.

In some embodiments, for each potential condition, the system executes a comparison of pre-set state requirements against the actual state of the trial participant's record. Should the comparison validate that all requisite states align with the actual state of the participant's record, the system then applies a condition flag to the participant's profile. This flag serves as an indicator of a particular status or condition pertinent to the clinical trial, such as a condition required for eligibility or a condition which precludes eligibility for the trial.

In some embodiments, an aspect of rules 127a is the incorporation of a comprehensive library of code sets and rules, including but not limited to the International Classification of Diseases, Tenth Revision (ICD-10) codes. This library encompasses an extensive array of codes for single conditions, which aid in the nuanced analysis and diagnosis of conditions within the clinical trial framework. The system is configured to navigate through multiple codes related to a single condition, facilitating more precise identification and application of specific conditions to participant profiles based on interpretation of diagnostic and laboratory result codes within the data object associated with the user.

In some embodiments, rules 127a account for equivalencies and threshold conditions among the codes, e.g., stipulating that if any code or a threshold value of codes within a specified subset meets or exceeds a threshold indicative of a condition, the condition is deemed satisfied, thereby warranting the application of a corresponding condition flag. This functionality may facilitate managing conditions represented by multiple diagnostic codes or where laboratory results play a key role in diagnosis.

In some embodiments, the machine-learning model(s) 127b, as part of the data enhancement module 126, are configured to analyze and predict various outcomes based on trial participant data within the context of clinical trials. These models include capabilities for predicting diseases or conditions based on received data, indicating retention risk for trial participants, and/or signaling the need for interventions to improve trial outcomes or participant adherence. Each model processes data relevant to trial participant demographics, health status, previous treatment responses, and other pertinent information to generate predictions about disease or condition development, participant retention likelihood, and intervention effectiveness.

To accomplish these objectives, the models utilize one or more machine learning algorithms to navigate through clinical trial and participant health data, e.g., identifying patterns and correlations that might not be evident via conventional techniques. This enables the data management platform 120 to generate insights into participant health trends, retention risks, and potential intervention strategies, facilitating more informed decision-making regarding trial management and participant engagement.

The machine-learning model(s) 127b continuously learn from new data and adapt to changes in trial conditions or participant health status, with the data enhancement module 126 updating the training of the models in response to received data about participant health and trial outcomes. This updating results in predictions and recommendations which stay accurate and relevant, providing a dynamic tool for the proactive management of clinical trials.

In some embodiments, the machine-learning model(s) 127b within the data enhancement module 126 are multi-modal, e.g., capable of incorporating and processing data from diverse formats, including, but not limited to, textual data, numerical data, and structured data formats. Specifically, these models are adept at analyzing a broad spectrum of clinical trial data, thereby enhancing their predictive capabilities concerning disease or condition onset, participant retention, and the necessity for intervention.

Furthermore, the machine-learning model(s) 127b, in embodiments, are configured to employ algorithms capable of processing various data types, including techniques suitable for analyzing structured clinical trial data alongside textual and numerical data analyses. It will be appreciated that a range of machine-learning models may be utilized, tailored to the specific needs and contexts of the clinical trial.

The training and ongoing refinement of the machine-learning model(s) 127b involve iterative adjustments of their parameters based on feedback from the system's performance and the introduction of new data. This process, in embodiments, includes retraining the models with updated participant and trial data, reflecting shifts in health trends, retention rates, or the effectiveness of interventions, as well as integrating new insights from continuous clinical research. The dynamic updating mechanism ensures that the machine-learning model(s) 127b remain better aligned with a current state of clinical trial practices and participant health conditions, enabling them to deliver pertinent and timely insights for optimizing trial management and participant care strategies.

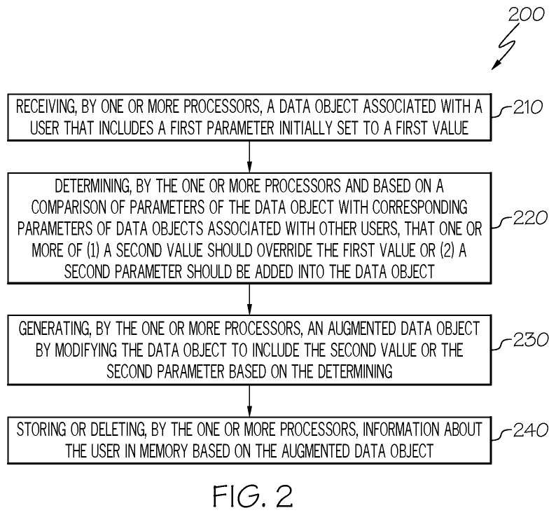

FIG. 2 is a flowchart showing a method for data enhancement. In some embodiments, at step 210, the method includes receiving, by one or more processors, a data object associated with a user that includes a first parameter initially set to a first value. This step initiates the process of data enhancement by introducing a foundational data object that serves as the initial input for subsequent analysis and processing. The data object, embodying a collection of information pertinent to a trial participant, encapsulates various parameters, among which the first parameter is of initial focus, bearing a predefined value that reflects a baseline or starting point for analysis.

In some embodiments, the receiving operation is executed within the context of a data management platform 120, wherein the one or more processors are configured to handle a multitude of data objects concurrently. The processors parse, interpret, and store data objects received from multiple sources, including electronic health records, participant surveys, or direct data inputs from clinical trial management systems. The act of receiving encompasses the validation and preliminary assessment of the data object to ensure its integrity and compatibility with the platform's data enhancement protocols.

In some embodiments, the first parameter within the data object is indicative of a specific aspect of the user's profile or health status, such as a biometric reading, a diagnostic code, a symptom, or an indicator of a condition. This parameter, by being set to a first value, presents an initial datum point from which the data enhancement process commences. The defined value of the first parameter may result from prior assessments, initial screenings, or baseline measurements taken at the outset of the user's engagement with the clinical trial.

In some embodiments, the data object received at step 210 may pertain to a single patient, or alternatively, it may relate to a population of patients, encompassing sub data objects for each patient's health record within the broader data object. Each patient health record within the sub data objects is characterized by a plurality of parameters, detailing various aspects of patient health, treatment history, and diagnostic outcomes.

In some embodiments, at step 220, the method further includes determining, by one or more processors, based on a comparison of parameters of the data object with corresponding parameters of data objects associated with other users, that one or more of (1) a second value should override the first value or (2) a second parameter should be added into the data object. This step enables the platform 120 to refine the accuracy of the patient's health record by adjusting or augmenting the data based on a comprehensive analysis of similar records. The determination process leverages both historical and current data from a wide array of patient records to enhance the specificity and relevance of each individual's health documentation.

In some embodiments, this step 220 involves identifying members who, based on documented conditions, appear eligible for a clinical trial or treatment protocol but are in reality ineligible due to an undocumented condition. This scenario typically occurs when the comparison reveals a second value—representing an undiagnosed or previously unreported condition—that necessitates overriding the first value, thereby altering the eligibility status of the member based on the newfound data.

In some embodiments, this step 220 includes identifying members initially deemed ineligible due to documented conditions but are found to be actually eligible when an undocumented condition is considered. Here, the addition of a second parameter into the data object serves to reveal eligibility by illuminating health aspects not previously documented. This process ensures that potential participants who might benefit from inclusion in a clinical trial or treatment are not overlooked due to incomplete health records.

In some embodiments, the determination process utilizes an algorithmic framework within the data management platform, applying a set of pre-defined rules and engaging machine-learning models trained to identify associations between parameters of the data object and specific test conditions. This dual approach of rule application and machine learning analysis accounts for a wider range of variables in the evaluation of patient records, facilitating a dynamic adjustment of data objects that accurately reflects each patient's health status.

In some embodiments, the comparison of parameters of the data object with corresponding parameters of data objects associated with other users is executed by applying the parameters of the data object to a plurality of pre-defined rules, each pre-defined rule associated with a respective test condition. These rules, which in some embodiments are referred to as suspecting rules, are configured to assess the presence or absence of specific conditions within a member's health record by identifying one or more states or flags indicated by the data entries of the member. The rules framework is structured to assess the congruence between the pre-set state requirements and the actual state of a member's record, ensuring that each potential condition is evaluated against the documented evidence.

In some embodiments, the application of these pre-defined rules involves an extensive library of code sets, including, but not limited to, the International Classification of Diseases, Tenth Revision (ICD-10) codes. This library facilitates the identification of dozens of codes that may correspond to a single medical condition, without necessitating a hierarchical structure among the codes. For each identified condition, a corresponding list of codes associated with that condition is referenced, enabling the system to detect conditions based on both diagnosis codes and laboratory results codes. The rules are configured to handle code equivalencies, whereby the satisfaction of any code within a certain subset, reaching a specific threshold, qualifies the conditional requirement as met.

In some embodiments, the rules-based system may encompass one or more conditions that may be required to be present or not present within the member's health data to be flagged as eligible, with the specification that one or more combinations of satisfactory conditions within a given rule could be sufficient to flag a condition for the member, contingent upon the configuration of the rule. This approach allows for a flexible evaluation framework, where the fulfillment of different combinations of criteria—reflective of the complex nature of health diagnostics and the variability in clinical presentations—can trigger the application of a condition flag.

In some embodiments, the process of determining at step 220 further encompasses applying the data object to a plurality of machine-learning models, where each machine-learning model within this plurality is specifically trained to discern associations between parameters of the data object and a designated test condition. This array of machine-learning models operates to systematically analyze the data object, employing sophisticated algorithms capable of recognizing complex patterns and correlations that may not be immediately apparent through conventional analysis methods. Each model is calibrated to focus on different aspects of the data object, ensuring a comprehensive evaluation of potential health conditions or risk factors indicated by the data. Through this application, the system leverages the aggregate analytical power of multiple machine-learning models to enhance the precision and reliability of the determination process, thereby facilitating a more accurate and informed decision-making framework for the inclusion of new or modified parameters within the data object.

In some embodiments, the machine learning models deployed within the system are designed to provide a probability output for each analyzed model and/or condition, quantifying the likelihood of a particular condition's presence within the data object. A threshold value is then compared against this output to determine the significance of the probability score. This threshold may be uniformly applied across all models, ensuring a consistent standard of evaluation, or it may be uniquely set for each model to accommodate the diverse nature of various conditions and their respective diagnostic criteria. Such a tailored approach allows for the nuanced assessment of conditions, ensuring that the probability outputs are evaluated in a context-appropriate manner.

In some embodiments, the comparison of parameters of the data object with corresponding parameters of data objects associated with other users involves applying the parameters of the data object to a plurality of pre-defined rules. This comparison of parameters includes comparing of the data object against established criteria to ascertain the presence or absence of specific conditions. Furthermore, the determining step is expanded to include the identification of a second value or the second parameter if the output from one or more rules of the plurality of pre-defined rules or one or more machine-learning models of the plurality indicates that the second value or the second parameter represents a target condition that warrants inclusion in the data object. This dual-faceted approach, leveraging both rule-based analysis and machine learning insights, enables a dynamic and nuanced assessment of health data, ensuring that critical health conditions, potentially undiagnosed or previously unidentified, are flagged for further attention.

In some embodiments, at step 230, the method includes generating, by the one or more processors, an augmented data object by modifying the data object to include the second value or the second parameter based on the determination made in the previous step. This process involves the actual alteration of the original data object to reflect new or updated information that has been identified as significant through the application of pre-defined rules and the analysis conducted by machine-learning models. The augmented data object, thus, represents a more accurate and comprehensive profile of the user's health status or trial eligibility, incorporating findings such as previously undiagnosed conditions or updated health parameters that are advantageous for accurate clinical trial management and patient care. This enhancement of the data object ensures that subsequent decisions regarding the user, whether related to trial inclusion, treatment options, or further diagnostic assessments, are based on the most complete and current information available, thereby optimizing the effectiveness of clinical interventions and trial outcomes.

In some embodiments, at step 240, the method involves storing or deleting, by the one or more processors, information about the user in memory based on the augmented data object. This step ensures that the updated information is accurately reflected in the user's profile and accessible for future reference or analysis. The decision to store or delete information is determined by the relevance and accuracy of the augmented data object, which has been refined through previous steps of the process. Storing the information involves updating the user's record in the database to include the newly identified or modified parameters, thereby enriching the data available for clinical trial management, patient monitoring, and decision-making processes. Conversely, deleting information may be warranted in cases where the augmented data object indicates that certain previously stored data is no longer relevant or accurate, ensuring the integrity and cleanliness of the data within the system.

In some embodiments, the method further includes generating, by the one or more processors, a retention score for the augmented data object by applying the augmented data object to a retention model. This retention model is a machine learning model that has been trained to identify associations between one or more parameters of the augmented data object and one or more retention metrics, effectively predicting the likelihood of a patient's continued participation in a clinical trial. The generation utilizes the detailed and enhanced data within the augmented data object to calculate one or more score that reflects the patient's probability of remaining engaged with the clinical trial over time.

In some embodiments, applying the augmented data object to the retention model results in the generation of a set of retention factors for the augmented data object. These retention factors are derived from various parameters related to the clinical trial and the user, which may include, but not limited to, heart disease score, relative income area, qualitative lab values, education level, number of prescribed medications (RX prescriptions), engagement score, distance from the test center, and the like. It should be understood that the foregoing examples are illustrative only, and that different trials would include selection of suitable factors Each factor within this set is associated with either a positive or negative impact on the probability of the user's retention within the clinical trial, with a specific magnitude assigned to indicate the extent of its influence. This magnitude reflects the degree to which each factor may affect user retention, enabling the retention model to accurately predict the likelihood of a user continuing in the clinical trial based on a comprehensive analysis of these multifaceted and individualized factors.

In some embodiments, the retention score generated for the augmented data object is ranked by the system and displayed to a user, facilitating the identification of target members for the clinical trial who are likely to be retained throughout the study period. This ranking mechanism enables trial administrators to strategically prioritize and recruit members based on their predicted retention likelihood. Furthermore, the system's capability to rank and display retention scores is usable to facilitate recruiting and/or selecting of additional members, thereby statistically improving the likelihood that a sufficient number of participants complete the trial. The additional recruitment may be based on the retention probability of the already recruited members and the retention probability of the additional members. This strategic over-recruitment is designed to mitigate the risk of trial failure due to retention issues, ensuring that the trial achieves its objectives even in the face of participant dropout, by maintaining a robust participant pool that accounts for potential attrition.

In some embodiments, the training the retention model is predicated on utilizing training data that encompasses one or more flags indicating instances where trial support was offered to participants. This allows the model to learn and quantify the significance of various mechanisms and data inputs in influencing trial retention rates. The training data is curated to include labeled training sets of individuals who have completed clinical trials as well as those who have dropped out. Through the analysis of these contrasting datasets and the adjustment of one or more parameter of the model, the retention model is adept at identifying patterns and factors that contribute to participant retention or attrition.

In some embodiments, the method further includes initiating, by the one or more processors, the performance of one or more actions in response to generating the retention score for the augmented data object. This initiating utilizes the retention score as a metric for determining the necessary interventions or modifications to enhance participant retention within a clinical trial. Based on the calculated retention score, which reflects the likelihood of a participant's continued engagement in the trial, the system is configured to automatically trigger specific actions aimed at addressing potential retention challenges. These actions may include, but are not limited to, personalized communication strategies, adjustments to participant support services, or the provision of additional resources designed to mitigate factors contributing to potential dropout. This proactive approach ensures that interventions are timely and tailored to the individual needs of participants, thereby optimizing the overall efficacy of the trial management process and bolstering the likelihood of achieving successful trial outcomes.

In some embodiments, the application of the retention model results in the assignment of a feature importance score to each metric within a member's profile, serving as an analytical basis for evaluating the potential impact of each metric on the member's likelihood to successfully complete the trial. The feature importance score may be similar to, or related to, or based on, one or more retention factor. This feature importance score delineates whether a specific metric will exert a positive or negative influence on the member's retention, offering a quantified insight into the factors that contribute to participant engagement and persistence within the clinical trial.

In some embodiments, each feature within the member's profile is weighted to indicate the relative significance of the feature in influencing the member's trial completion prospects. For instance, if a member resides significantly far from the testing center, the metric representing the distance to the center may be assigned a substantial weight as a detractor for member retention. This weighting system allows for a nuanced understanding of how individual characteristics and situational factors might affect a participant's journey through the trial.

In some embodiments, based on the calculated feature importance, personalized support is formulated either automatically by the system, based on pre-determined criteria, or manually by a user who can specify one or more support interventions for the member. This personalized support tailors the trial experience to individual participant needs, leveraging the insights gained from the feature importance scores to implement targeted support strategies that address identified barriers to retention.

In some embodiments, support conditions are applied prior to the selection of members, thereby informing the trial enrollment process by indicating the types of support that can be extended to members which may, in turn, influence the overall member eligibility and/or affect one or more retention metrics of the member. For example, if the trial is equipped to offer comprehensive transportation solutions, the significance of distance from the test center as a retention metric may be accordingly diminished, reflecting the mitigated impact of this factor on participant retention.

In some embodiments, while not every metric may warrant a direct intervention, the system is configured to ascribe one or more interventions to a user if their feature importance score surpasses a predefined threshold. In some embodiments, the interventions are strategically allocated to address the most significant predictors of dropout, optimizing resource utilization and enhancing participant support.

In some embodiments, the retention model and the associated support interventions are configured to be dynamically updated and reapplied during the course of the trial with refreshed information. This iterative process enables the continuous refinement of feature weighting and support tailoring, ensuring that participant support mechanisms remain responsive to evolving participant needs and circumstances throughout the trial duration.

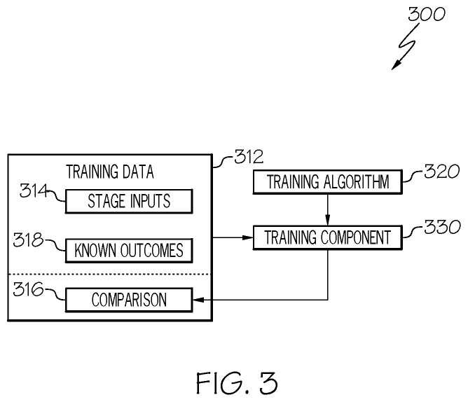

One or more implementations disclosed herein include and/or are implemented using a machine-learning model. For example, one or more of the modules of the data management platform 120 are implemented using a machine-learning model and/or are used to train the machine-learning model. FIG. 3 shows an example machine-learning training flow chart, according to some embodiments of the disclosure. Referring to FIG. 3, a given machine-learning model is trained using the training flow chart 300. The training data 312 includes one or more of stage inputs 314 and the known outcomes 318 related to the machine-learning model to be trained. The stage inputs 314 are from any applicable source including text, visual representations, data, values, comparisons, and stage outputs, e.g., one or more outputs from one or more steps from FIG. 2. The known outcomes 318 are included for the machine-learning models generated based on supervised or semi-supervised training, or can based on known labels, such as topic labels. An unsupervised machine-learning model is not trained using the known outcomes 318. The known outcomes 318 includes known or desired outputs for future inputs similar to or in the same category as the stage inputs 314 that do not have corresponding known outputs.

The training data 312 and a training algorithm 320, e.g., one or more of the modules implemented using the machine-learning model and/or are used to train the machine-learning model, is provided to a training component 330 that applies the training data 312 to the training algorithm 320 to generate the machine-learning model. According to an implementation, the training component 330 is provided comparison results 316 that compare a previous output of the corresponding machine-learning model to apply the previous result to re-train the machine-learning model. The comparison results 316 are used by the training component 330 to update the corresponding machine-learning model. The training algorithm 320 utilizes machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIG. 2 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

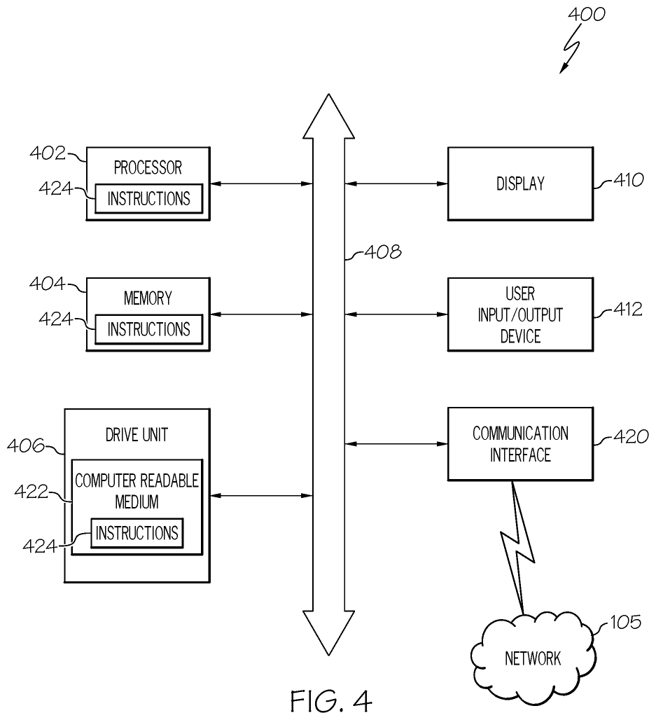

FIG. 4 illustrates an implementation of a computer system that executes techniques presented herein. The computer system 400 includes a set of instructions that are executed to cause the computer system 400 to perform any one or more of the methods or computer based functions disclosed herein. The computer system 400 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 400 operates in the capacity of a server or as a client user computer in a server-client user environment, or as a peer computer system in a peer-to-peer (or distributed) environment. The computer system 400 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 400 is implemented using electronic devices that provide voice, video, or data communication. Further, while the computer system 400 is illustrated as a single system, the term “system” shall also be taken to include any collection of systems or sub-systems that individually or jointly execute a set, or multiple sets, of instructions to perform one or more computer functions.

As illustrated in FIG. 4, the computer system 400 includes a processor 402, e.g., a central processing unit (CPU), a graphics processing unit (GPU), or both. The processor 402 is a component in a variety of systems. For example, the processor 402 is part of a standard personal computer or a workstation. The processor 402 is one or more processors, digital signal processors, application specific integrated circuits, field programmable gate arrays, servers, networks, digital circuits, analog circuits, combinations thereof, or other now known or later developed devices for analyzing and processing data. The processor 402 implements a software program, such as code generated manually (i.e., programmed).

The computer system 400 includes a memory 404 that communicates via bus 408. The memory 404 is a main memory, a static memory, or a dynamic memory. The memory 404 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts, or tasks illustrated in the figures or described herein are performed by the processor 402 executing the instructions stored in the memory 404. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 400 further includes a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 acts as an interface for the user to see the functioning of the processor 402, or specifically as an interface with the software stored in the memory 404 or in the drive unit 406.

Additionally or alternatively, the computer system 400 includes an input/output device 412 configured to allow a user to interact with any of the components of the computer system 400. The input/output device 412 is a number pad, a keyboard, a cursor control device, such as a mouse, a joystick, touch screen display, remote control, or any other device operative to interact with the computer system 400.

The computer system 400 also includes the drive unit 406 implemented as a disk or optical drive. The drive unit 406 includes a computer-readable medium 422 in which one or more sets of instructions 424, e.g. software, is embedded. Further, the sets of instructions 424 embodies one or more of the methods or logic as described herein. The sets of instructions 424 resides completely or partially within the memory 404 and/or within the processor 402 during execution by the computer system 400. The memory 404 and the processor 402 also include computer-readable media as discussed above.

In some systems, computer-readable medium 422 includes the set of instructions 424 or receives and executes the set of instructions 424 responsive to a propagated signal so that a device connected to network 105 communicates voice, video, audio, images, or any other data over the network 105. Further, the sets of instructions 424 are transmitted or received over the network 105 via the communication port or interface 420, and/or using the bus 408. The communication port or interface 420 is a part of the processor 402 or is a separate component. The communication port or interface 420 is created in software or is a physical connection in hardware. The communication port or interface 420 is configured to connect with the network 105, external media, the display 410, or any other components in the computer system 400, or combinations thereof. The connection with the network 105 is a physical connection, such as a wired Ethernet connection, or is established wirelessly as discussed below. Likewise, the additional connections with other components of the computer system 400 are physical connections or are established wirelessly. The network 105 alternatively be directly connected to the bus 408.

While the computer-readable medium 422 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 422 is non-transitory, and may be tangible.

The computer-readable medium 422 includes a solid-state memory such as a memory card or other package that houses one or more non-volatile read-only memories. The computer-readable medium 422 is a random-access memory or other volatile re-writable memory. Additionally or alternatively, the computer-readable medium 422 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 400 is connected to the network 105. The network 105 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. The network 105 includes wide area networks (WAN), such as the Internet, local area networks (LAN), campus area networks, metropolitan area networks, a direct connection such as through a Universal Serial Bus (USB) port, or any other networks that allows for data communication. The network 105 is configured to couple one computing device to another computing device to enable communication of data between the devices. The network 105 is generally enabled to employ any form of machine-readable media for communicating information from one device to another. The network 105 includes communication methods by which information travels between computing devices. The network 105 is divided into sub-networks. The sub-networks allow access to all of the other components connected thereto or the sub-networks restrict access between the components. The network 105 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the instructions for carrying out such a method or element of a method forms a means for carrying out the method or element of a method. Furthermore, an element described herein of an apparatus embodiment is an example of a means for carrying out the function performed by the element for the purpose of carrying out the disclosure.

In the description provided herein, numerous specific details are set forth. However, it is understood that embodiments of the disclosure are practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognize that other and further modifications are made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure.

Accordingly, the disclosure is not to be restricted except in light of the attached claims and their equivalents.

The present disclosure furthermore relates to the following aspects:

Example 1. A computer-implemented method comprising: receiving, by one or more processors, a data object associated with a user that includes a first parameter initially set to a first value; determining, by the one or more processors and based on a comparison of parameters of the data object with corresponding parameters of data objects associated with other users, that one or more of (1) a second value should override the first value or (2) a second parameter should be added into the data object; generating, by the one or more processors, an augmented data object by modifying the data object to include the one or more of the second value or the second parameter based on the determining; and storing or deleting, by the one or more processors, information about the user in memory based on the augmented data object.

Example 2. The computer-implemented method of example 1, wherein the comparison of the parameters of the data object with the corresponding parameters of data objects associated with the other users is based on applying the parameters of the data object to a plurality of pre-defined rules, each pre-defined rule associated with a respective test condition.

Example 3. The computer-implemented method of any of examples 1-2, wherein the determining further includes applying the data object to a plurality of machine-learning models, wherein each machine-learning model of the plurality of machine-learning models is trained to identify associations between parameters of the data object and a respective test condition.

Example 4. The computer-implemented method of example 3, wherein the comparison of parameters of the data object with corresponding parameters of data objects associated with other users is based on applying the parameters of the data object to a plurality of pre-defined rules, and wherein the determining further includes identifying the second value or the second parameter upon determining that an output of one or more rules of the plurality of pre-defined rules or one or more machine-learning models of the plurality of machine-learning models indicates that the second value or the second parameter is a target condition that should be added to the data object.

Example 5. The computer-implemented method of example 4, wherein the target condition is an undiagnosed medical condition.

Example 6. The computer-implemented method of any of examples 1-5, further comprising: generating, by the one or more processors, a retention score for the augmented data object by applying the augmented data object to a retention model.

Example 7. The computer-implemented method of example 6, wherein the retention model includes a machine learning model trained to identify associations between one or more parameters of the augmented data object and one or more retention metrics.

Example 8. The computer-implemented method of any of examples 6-7, wherein applying the augmented data object to the retention model generates a set of retention factors for the augmented data object.

Example 9. The computer-implemented method of any of examples 6-8, further comprising: initiating, by the one or more processors, based on the retention score for the augmented data object, performance of one or more actions in response to generating the retention score for the augmented data object.

Example 10. The computer-implemented method of example 9, wherein initiating the performance of the one or more actions includes generating an intervention for the user based on the retention score.

Example 11. A system comprising memory and one or more processors communicatively coupled to the memory, the one or more processors configured to: receive a data object associated with a user that includes a first parameter initially set to a first value; determine, based on a comparison of parameters of the data object with corresponding parameters of data objects associated with other users, that one or more of (1) a second value should override the first value or (2) a second parameter should be added into the data object; generate, by the one or more processors, an augmented data object by modifying the data object to include the one or more of second value or the second parameter based on the determining; and store or delete, by the one or more processors, information about the user in memory based on the augmented data object.

Example 12. The system of example 11, wherein the comparison of the parameters of the data object with the corresponding parameters of data objects associated with the other users is based on applying the parameters of the data object to a plurality of pre-defined rules, each pre-defined rule associated with a respective test condition.

Example 13. The system of any of examples 11-12, wherein the determining further includes applying the data object to a plurality of machine-learning models, wherein each machine-learning model of the plurality of machine-learning models is trained to identify associations between parameters of the data object and a respective test condition.

Example 14. The system of example 13, wherein the comparison of parameters of the data object with corresponding parameters of data objects associated with other users is based on applying the parameters of the data object to a plurality of pre-defined rules, and wherein the determining further includes identifying the second value or the second parameter upon determining that an output of one or more rules of the plurality of pre-defined rules or one or more machine-learning models of the plurality of machine-learning models indicates that the second value or the second parameter is a target condition that should be added to the data object.

Example 15. The system of any of examples 11-14, wherein the one or more processors are further configured to: generate a retention score for the augmented data object by applying the augmented data object to a retention model.

Example 16. The system of example 15, wherein the retention model includes a machine learning model trained to identify associations between one or more parameters of the augmented data object and one or more retention metrics.

Example 17. The system of any of examples 15-16, wherein applying the augmented data object to the retention model generates a set of retention factors for the augmented data object.

Example 18. The system of any of examples 15-17, wherein the one or more processors are further configured to: initiate, based on the retention score for the augmented data object, performance of one or more actions in response to generating the retention score for the augmented data object.

Example 19. The system of example 18, wherein initiating the performance of the one or more actions includes generating an intervention for the user based on the retention score.

Example 20. One or more non-transitory computer-readable storage media including instructions that, when executed by one or more processors, cause the one or more processors to: receive a data object associated with a user that includes a first parameter initially set to a first value; determine, based on a comparison of parameters of the data object with corresponding parameters of data objects associated with other users, that one or more of (1) a second value should override the first value or (2) a second parameter should be added into the data object; generate, by the one or more processors, an augmented data object by modifying the data object to include the one or more of second value or the second parameter based on the determining; and store or delete, by the one or more processors, information about the user in memory based on the augmented data object.

Example 21. The computer-implemented method of any of Examples 3 and 7, wherein the training of the machine learning model is performed by the one or more processors.

Example 22. The computer-implemented method of any of Examples 3 and 7, wherein: the one or more processors are included in a first computing entity; and the training of the machine learning model is performed by one or more processors included in a second computing entity.

What is claimed is:

1. A computer-implemented method comprising:
receiving, by one or more processors, a data object associated with a user that includes a first parameter initially set to a first value;
determining, by the one or more processors and based on a comparison of parameters of the data object with corresponding parameters of data objects associated with other users, that one or more of (1) a second value should override the first value or (2) a second parameter should be added into the data object;
generating, by the one or more processors, an augmented data object by modifying the data object to include the one or more of the second value or the second parameter based on the determining; and
storing or deleting, by the one or more processors, information about the user in memory based on the augmented data object.

2. The computer-implemented method of claim 1, wherein the comparison of the parameters of the data object with the corresponding parameters of data objects associated with the other users is based on applying the parameters of the data object to a plurality of pre-defined rules, each pre-defined rule associated with a respective test condition.

3. The computer-implemented method of claim 1, wherein the determining further includes applying the data object to a plurality of machine-learning models, wherein each machine-learning model of the plurality of machine-learning models is trained to identify associations between parameters of the data object and a respective test condition.

4. The computer-implemented method of claim 3, wherein the comparison of parameters of the data object with corresponding parameters of data objects associated with other users is based on applying the parameters of the data object to a plurality of pre-defined rules, and wherein the determining further includes identifying the second value or the second parameter upon determining that an output of one or more rules of the plurality of pre-defined rules or one or more machine-learning models of the plurality of machine-learning models indicates that the second value or the second parameter is a target condition that should be added to the data object.

5. The computer-implemented method of claim 4, wherein the target condition is an undiagnosed medical condition.

6. The computer-implemented method of claim 1, further comprising: generating, by the one or more processors, a retention score for the augmented data object by applying the augmented data object to a retention model.

7. The computer-implemented method of claim 6, wherein the retention model includes a machine learning model trained to identify associations between one or more parameters of the augmented data object and one or more retention metrics.

8. The computer-implemented method of claim 6, wherein applying the augmented data object to the retention model generates a set of retention factors for the augmented data object.

9. The computer-implemented method of claim 6, further comprising: initiating, by the one or more processors, based on the retention score for the augmented data object, performance of one or more actions in response to generating the retention score for the augmented data object.

10. The computer-implemented method of claim 9, wherein initiating the performance of the one or more actions includes generating an intervention for the user based on the retention score.

11. A system comprising memory and one or more processors communicatively coupled to the memory, the one or more processors configured to:
receive a data object associated with a user that includes a first parameter initially set to a first value;
determine, based on a comparison of parameters of the data object with corresponding parameters of data objects associated with other users, that one or more of (1) a second value should override the first value or (2) a second parameter should be added into the data object;
generate, by the one or more processors, an augmented data object by modifying the data object to include the one or more of second value or the second parameter based on the determining; and
store or delete, by the one or more processors, information about the user in memory based on the augmented data object.

12. The system of claim 11, wherein the comparison of the parameters of the data object with the corresponding parameters of data objects associated with the other users is based on applying the parameters of the data object to a plurality of pre-defined rules, each pre-defined rule associated with a respective test condition.

13. The system of claim 11, wherein the determining further includes applying the data object to a plurality of machine-learning models, wherein each machine-learning model of the plurality of machine-learning models is trained to identify associations between parameters of the data object and a respective test condition.

14. The system of claim 13, wherein the comparison of parameters of the data object with corresponding parameters of data objects associated with other users is based on applying the parameters of the data object to a plurality of pre-defined rules, and wherein the determining further includes identifying the second value or the second parameter upon determining that an output of one or more rules of the plurality of pre-defined rules or one or more machine-learning models of the plurality of machine-learning models indicates that the second value or the second parameter is a target condition that should be added to the data object.

15. The system of claim 11, wherein the one or more processors are further configured to: generate a retention score for the augmented data object by applying the augmented data object to a retention model.

16. The system of claim 15, wherein the retention model includes a machine learning model trained to identify associations between one or more parameters of the augmented data object and one or more retention metrics.

17. The system of claim 15, wherein applying the augmented data object to the retention model generates a set of retention factors for the augmented data object.

18. The system of claim 15, wherein the one or more processors are further configured to: initiate, based on the retention score for the augmented data object, performance of one or more actions in response to generating the retention score for the augmented data object.

19. The system of claim 18, wherein initiating the performance of the one or more actions includes generating an intervention for the user based on the retention score.

20. One or more non-transitory computer-readable storage media including instructions that, when executed by one or more processors, cause the one or more processors to:
receive a data object associated with a user that includes a first parameter initially set to a first value;
determine, based on a comparison of parameters of the data object with corresponding parameters of data objects associated with other users, that one or more of (1) a second value should override the first value or (2) a second parameter should be added into the data object;
generate, by the one or more processors, an augmented data object by modifying the data object to include the one or more of second value or the second parameter based on the determining; and
store or delete, by the one or more processors, information about the user in memory based on the augmented data object.
